(19) United States
(12) Patent Application Publication
(10) Pub. No.: US 2006/0200303 A1
(43) Pub. Date: Sep. 7, 2006

(54) The static or dynamic roadway travel time system to determine the path with least travel time between two places

(76) Inventors: Jorge Salomon Fuentes, Santa Clarita, CA (US); Raymond Moberly, San Diego, CA (US); Yuan Feng Ouyang, Claremont, CA (US)

Correspondence Address: JORGE SALOMON FUENTES, P.O. BOX 2826, SANTA CLARITA, CA, 91386, US

(21) Appl. No.: 11/307,835

(22) Filed: Feb. 24, 2006

Related U.S. Application Data
(60) Provisional application No. 60/655,275, filed on Feb. 24, 2005.

(51) Int. Cl. G01C 21/36

(52) U.S. Cl. 701/200

(57) ABSTRACT

The static or dynamic roadway travel time system determines the path with least travel time 26, 28 between two places by using user input 8 and traffic data input 14 in the form of volume and occupancy, or speed, or travel time to inform a user of the roadway network path that yields the least travel time 26, 28.

### CROSS-REFERENCE TO RELATED APPLICATIONS

This application claims the benefit of provisional patent application No. 60/655,275 filed on Feb. 24, 2005 by the present inventors.

### FEDERALLY SPONSORED RESEARCH OR DEVELOPMENT

Not Applicable.

### JOINT RESEARCH AGREEMENT

Not Applicable.

### SEQUENCE LISTING OR COMPUTER PROGRAM

Computer program listings attached are:

| | |
|---|---|
| BELLMANFORD | 3 KB |
| DISTANCE_SHORTEST_PATH | 2 KB |
| DYNAMIC_SHORTEST_PATH | 2 KB |
| GET_DTIME | 1 KB |
| LINKS_COST | 1 KB |
| READ_DISTANCES | 1 KB |
| READ_MEANS_AND_VARIANCES | 1 KB |
| READ_NETWORK | 1 KB |
| REDUCED_STATIC_SHORTEST_PATH | 3 KB |
| STATIC_SHORTEST_PATH | 2 KB |

### BACKGROUND

1. Field of the Invention

This invention relates to a process for modeling a travel time system, specifically to such systems which are used for predicting the path with least travel time using simulation.

2. Related Art

Originally, travel time information provided by non-navigational systems was based on a deterministic model using distance and average speed to determine travel time.

Thereafter, U.S. Pat. No. 4,301,506 (1981) proposed a navigational system that required little or no intervention from the vehicle operator but the route was not necessarily the one with least travel time.

Later, other patents proposed other methods for calculating or predicting travel time but both vehicle navigational systems and remote central computers are needed. For example: US patent RE38,724 (2005) proposes calculation of travel time based on the variation of instant rates of travel. U.S. Pat. No. 5,933,100 (1999) proposes calculation of travel time based on moving averages of current travel times. U.S. Pat. No. 5,774,827 (1998) claims no method for calculating travel time. U.S. Pat. No. 6,882,930 (2005) calculates predicted traffic delays using least squares fit analysis but does not calculate travel time. U.S. Pat. No. 0,216,857 (2003) calculates travel time based on confidence factors without user input. U.S. Pat. No. 6,317,686 (2001) calculates travel time based on driver type and vehicle type. U.S. Pat. No. 6,209,026 (2001) provides driving conditions along selected route. U.S. Pat. No. 5,610,821 (1997) uses forecasts of occupancy and congestion to determine an optimal route. U.S. Pat. No. 5,297,049 (1994) uses prediction of congestion not travel time to determine alternate route. U.S. Pat. No. 4,350,970 (1982) calculates travel time based on changing mean values from measured travel times. U.S. Pat. No. 6,915,207 (2005) calculates travel time from road data and set speed, and from detected node passing times. U.S. Pat. No. 6,119,095 (2000) uses an itinerary preparation system for preparing travel plans. US patent application 20040249568 uses non specified traffic information collected in the past and statistical data including travel time or moving speed. US patent application 20050096842 predicts travel time from traffic incident data found in a remote data server. US patent application 20050107945 calculates travel time using vehicles traveling in a sequence of vehicles.

The related art pertains to navigational systems which require a remote central system to provide travel time information in a vehicle. The invention pertains to a very specific process for predicting travel time between two places using simulation. The invention uses traffic data in the form of vehicles per hour, volume and occupancy, speed, or travel time, then converts it to probability density function parameters of a Gaussian distribution, mean and variance, and uses the parameters for the random variables in static model, and random processes in dynamic model. A simulation predicts travel time using the statistical parameters and a search algorithm is used to find the path with the least travel time.

This invention makes it possible to estimate travel time between two places using processed traffic data and user input without the need of a vehicle, a vehicle navigational system, and a remote central system. This invention also makes it possible for every individual with a platform to execute the process to have travel time information.

One implementation of this system is described on Traffic Network Shortest Path © 2005 Jorge Salomon Fuentes USCO Registration TXu1-217-888 which was presented in a classroom at Claremont Graduate University in May 2003, and subsequently described on Traffic Network Shortest Path presented at SIAM Conference on Computational Science & Engineering on Feb. 15, 2005. In this implementation, travel time is computed from traffic data in the form of vehicles per hour. Each of Traffic Network Shortest Path is incorporated herein by reference as non-essential material.

Travel time can also be computed from traffic data in the form of volume and occupancy, or speed using the spatial travel time equation derived by the author in a paper submitted to the ITE Technical Conference and Exhibit 2005 which is incorporated herein by reference as non-essential material. Travel time Gaussian random variables are used, but this system could also use pseudo Gaussian random variables derived from the general spline function included in a Faculty Mentor Program Research Report, UCI 1987 written by Jorge Salomon Fuentes. Unknown speed can be calculated using Traffic Network Speed Equation described in Topological Analysis of the Traffic Intersection—General Case © 2005 Jorge Salomon Fuentes USCO Registration TXu1-217-888 which is incorporated herein by reference as non-essential material.

### BRIEF SUMMARY

The purpose of the invention is to determine the least travel time between two places considering not just distance but also traffic conditions. The user can provide information needed by the system to determine the least travel time between two arbitrary places to decide whether or not the travel is desirable at a given departure time, or to decide whether or not permanent relocation to one of the places is desirable.

The nature of the invention is to provide travel time information to users that are not operating a vehicle.

### BRIEF DESCRIPTION OF THE VIEWS OF THE DRAWING

### 1. List of Drawings

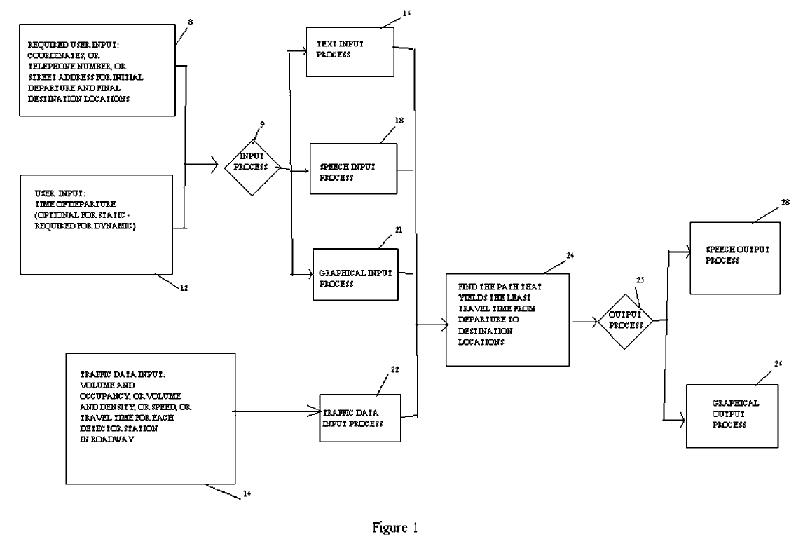

FIG. 1 is a System Flowchart.

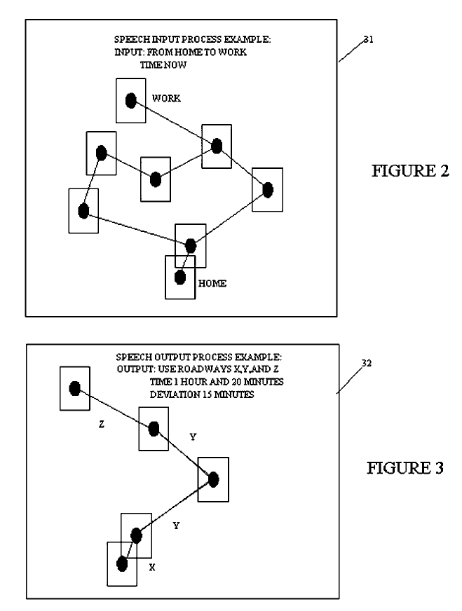

FIG. 2 is a Speech Input Example.

FIG. 3 is a Speech Output Example.

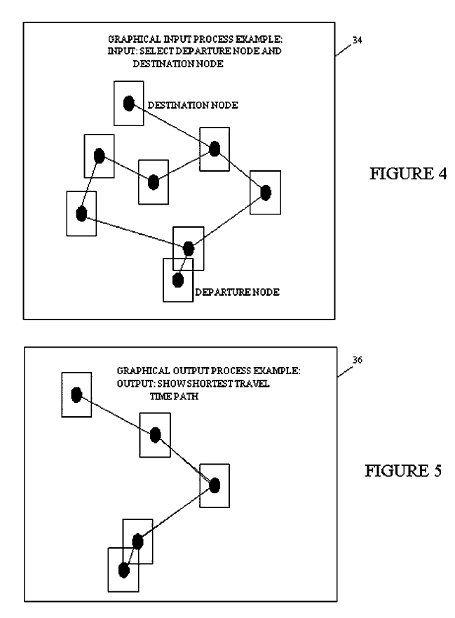

FIG. 4 is a Graphical Input Example.

FIG. 5 is a Graphical Output Example.

### 2. Reference Numerals

8 Required User Input
9 Input Process
12 Optional User Input
14 Traffic Data Input
16 Text Input Process
18 Speech Input Process
21 Graphical Input Process
22 Traffic Data Input Process
24 Modeling and Simulation Process
25 Output Process
26 Graphical Output Process
28 Speech Output Process
31 Speech Input Example
32 Speech Output Example
34 Graphical Input Example
36 Graphical Output Example

### DETAILED DESCRIPTION

The static or dynamic roadway travel time system determines the path with least travel time between two places by using traffic data input 14 in the form of volume and occupancy, or speed, or travel time to inform a user of the roadway network path that yields the least travel time.

The user input 8 may be either text 16, speech 18, or graphical 21 and provides either the graphical location, coordinates, telephone number, or street address of the departure location and the destination location.

The static method 24 for travel time does not require time of departure and calculates the travel time for each graph link using a random variable (example: Gaussian) based on travel time from the twenty four hours of the day and seven days of the week. Then, the method finds the path that yields the least travel time from the departure location to the destination location.

The dynamic method 24 needs to know the time of departure 12 and uses hourly traffic data 14 and a random process based on travel time to calculate hourly travel time for each link on the graph used in the paths used in the search. Then, the algorithm dynamically finds the best path that yields the best travel time by determining at each node the node departure time based on the departure time from the previous node and the time dependent travel time between the two nodes, and selecting the proper path at each node that yields than one path to the destination location. At each node, the node departure time determines what hourly traffic data will be used to calculate the travel time; likewise, each node departure travel time determines the travel time random variable to be derived from the travel time random process.

The least travel time 26,28 is calculated or derived from a simulation using the random variable which includes recurring and non-recurring traffic conditions. Travel time can be computed from traffic data 14 in the form of volume and occupancy, or speed. Travel time Gaussian random variables used, but this system could also use pseudo Gaussian random variables. Unknown speed or travel time can be calculated using the traffic network speed equation.

Text Input 16 can be used for coordinates, telephone number, or street address.

Speech Input 18 can be used either for coordinates, telephone number, or street address. The speech recognizer is user independent and uses frequency domain samples for each word, then normalizes, then calculates a centroid and uses the centroid to compare normalized frequency domain samples from user input and normalized frequency domain samples from the speech recognizer word list to determine the user command.

Graphical Input 21 is used to select graphically from a map the departure location and the destination location. The map used for graphical input can be either geographical or a planar graph.

What is claimed is:

1. A static process for modeling a travel time system, comprising:
(a) Converting traffic data in the form of vehicles per hour, volume and occupancy, volume and density, speed, and travel time into Gaussian random variables of travel time
(b) Associating one or more Gaussian random variables from (a) with a link of a graph representing a roadway network
(c) Acquiring user input in the form of text, speech, or graphical to determine departure location and destination location, and identifying nodes in the graph from (b) corresponding to locations selected by user
(d) Providing an estimated travel time for each link of the graph from (b) using Gaussian random variables from (b)
(e) Simulating several scenarios of travel time using estimated travel time from (d) for each link connecting nodes identified in (c), and determining the shortest travel time path using shortest path algorithm for each scenario of travel time
(f) Estimating least travel time by selecting path most visited during simulation in (e)
(g) Providing results from (f) in speech and graphical output.

2. A dynamic process for modeling a travel time system, comprising:
(h) Converting time dependent traffic data in the form of vehicles per hour, volume and occupancy, volume and density, speed, and travel time into Gaussian random processes of travel time
(i) Associating one or more Gaussian random processes from (h) with a link of a graph representing a roadway network, and sampling Gaussian random processes to obtain Gaussian random variables
(j) Acquiring user input in the form of text, speech, or graphical to determine departure location, departure time, and destination location, and identifying nodes in the graph from (i) corresponding to locations selected by user
(k) Providing a time dependent estimated travel time for each link of the graph from (i) using Gaussian random processes from (i)
(l) Simulating several scenarios of travel time using estimated travel time from (k) for each link connecting nodes identified in (j), sampling Gaussian random processes from (h) to obtain Gaussian random variables at the time a node in the graph from (i) is visited, and determining the shortest travel time path using shortest path algorithm for each scenario of travel time
(m) Estimating least travel time by selecting path most visited during simulation in (l)
(n) Providing results from (m) in speech and graphical output.

3. A process for modeling a travel time system, comprising:
(o) combination of static process from claim 1, dynamic process from claim 2, and deterministic model
(p) Simulating several scenarios of travel time using a combination of the methods in (o) to estimate travel time for each link connecting nodes identified in (j) or (c), sampling as needed Gaussian random processes from (h) to obtain Gaussian random variables at the time a node in the graph from (i) or (b) is visited, and determining the shortest travel time path using shortest path algorithm for each scenario of travel time
(q) Estimating least travel time by selecting path most visited during simulation in (p)
(r) Providing results from (q) in speech and graphical output.
